(19) United States
(12) Patent Application Publication
(10) Pub. No.: US 2015/0280246 A1
(43) Pub. Date: Oct. 1, 2015

(54) METHOD FOR PRODUCING CATALYST AND CATALYST

(71) Applicant: KABUSHIKIKAISHA EQUOS RESEARCH, Tokyo (JP)

(72) Inventors: Hidemi Kato, Sapporo (JP); Katsuhiko Saguchi, Sapporo (JP); Nana Hayakawa, Sapporo (JP)

(73) Assignee: KABUSHIKIKAISHA EQUOS RESEARCH, Tokyo (JP)

(21) Appl. No.: 14/431,354

(22) PCT Filed: Oct. 16, 2013
(86) PCT No.: PCT/JP2013/078091

§ 371 Date: Mar. 26, 2015

(30) Foreign Application Priority Data
Oct. 16, 2012 (JP) 2012-228541

(51) Int. Cl. H01M 4/90; H01M 4/92; H01M 4/88

(52) U.S. Cl. CPC H01M 4/9083; H01M 4/8803; H01M 4/926

(57) ABSTRACT

The present invention makes it possible to efficiently utilize catalyst metal particles of a catalyst by fuel cell reaction. In a PFF structure in which a hydrophilic region is formed between the surface of a catalyst and an electrolyte, water is confined within the layer of the electrolyte, therefore by modifying the surface of a carrier by an acidic functional group, particularly by a sulfonic acid group, this acidic functional group is always in contact with the water, and thus protons are supplied therefrom into the water. Consequently, even in an environment, for example, in a micropore of the catalyst, into which the electrolyte cannot get, the protons from the acidic functional group are supplied to catalyst metal particles present at the peripheral surface of the micropore, and the catalyst metal particles contribute to fuel cell reaction.

### TECHNICAL FIELD

The present invention relates to a method for producing a catalyst for a reaction layer of a fuel cell having a PFF structure and a catalyst obtained by the production method.

### BACKGROUND ART

A membrane electrode assembly for use in a fuel cell has a structure including a solid polymer electrolyte membrane sandwiched between a hydrogen electrode and an air electrode, the hydrogen electrode and air electrode being each obtained by sequentially laminating a reaction layer and a diffusion layer from the side of the solid polymer electrolyte membrane.

The reaction layer is made of a mixture of a catalyst and an electrolyte, and is required to have conductivity of electrons and protons and air permeability. Here, protons move together with water in the form of H₃O⁺, and thus the reaction layer must be maintained in a wet state. Of course, since the air permeability is inhibited when water is excessively present in the reaction layer (so called, flooding phenomenon), the moisture contained in the reaction layer must be constantly maintained in an appropriate amount. Here, the catalyst is such that particles of a catalyst metal such as platinum are dispersed on the surface of a conductive carrier such as carbon.

See Patent Document 3 and Non-Patent Documents 1 to 3 as documents which disclose techniques associated with the present invention.

### PRIOR ART DOCUMENTS

### Patent Documents

Patent Document 1: JP 2006-140061 A

Patent Document 2: JP 2006-140062 A

Patent Document 3: JP 2009-104905 A

### Non-Patent Documents

Non-Patent Document 1: Journal of Electrochemical Society 2005, vol. 152, No. 5, PP. A970-A977 MAKHARIA Rohit; MATHIAS Mark F.; BAKER Daniel R. “Measurement of catalyst layer electrolyte resistance in PEFCs using electrochemical impedance spectroscopy”

Non-Patent Document 2: Journal of Electroanalytical Chemistry 475, 107-123 (1999) M. Eikerling and A. A. kornyshev “electrochemical impedance of Cathode Catalyst Layer of Polymer Electrolyte Fuel Cells”

Non-Patent Document 3: “Electrochemical Impedance Method” (Maruzen Co., Ltd., Masayuki Itagaki), Chapter 8, Electrochemical Impedance Analysis Using Distributed Constant Type Equivalent Circuit (pp. 133-146)

### SUMMARY OF THE INVENTION

### Problems to be Solved by the Invention

Although electrons, protons, and oxygen must be supplied to catalyst metal particles of a catalyst in order to cause a fuel cell reaction, an electrolyte cannot generally get into micropores having a size of several nanometers or less in a catalyst carrier made of porous carbon or the like, and thus no proton is supplied into the micropores. Thus, the catalyst metal particles supported on the inner peripheral surfaces of the micropores cannot contribute to the fuel cell reaction.

Similarly, when a catalyst constitutes multi-order particles, an electrolyte cannot get even into fine gaps formed among the catalyst particles, and thus the catalyst metal particles exposed to the gaps cannot contribute to the fuel cell reaction.

Thus, the present invention aims at ensuring effective utilization of the catalyst metal particles of a catalyst through a fuel cell reaction.

### Solutions to the Problems

As a result of earnest studies in order to attain the above-described object, the present inventors have considered that, since water is confined inside the layer of an electrolyte in the PFF structure where a hydrophilic region is formed between the surface of a catalyst and an electrolyte, the modification of the surface of a carrier with an acidic functional group allows this acidic functional group to be always in contact with water, and thus that protons are imparted to the catalyst metal particles from this group, whereby the catalyst metal particles would contribute to the fuel cell reaction.

Examples of the acidic functional group include a hydroxyl group, a carboxyl group, a carbonyl group, a sulfonic acid group, a nitro group, a nitric acid group, a nitrous acid group, and a phosphate group.

A first aspect of the present invention is defined as follows:

a catalyst for a fuel cell including a conductive carrier on which catalyst metal particles are supported, wherein

the surface of the carrier is modified with an acidic functional group, and the acidic functional group is one or two or more of a hydroxyl group, a carboxyl group, a carbonyl group, a sulfonic acid group, a nitro group, a nitric acid group, a nitrous acid group, and a phosphate group.

A second aspect of the present invention is defined as follows:

the catalyst for a fuel cell as defined in the first aspect, wherein the catalyst has a Hammett acidity function of −3 or less.

According to the present inventors' reviews, it has been found that, when the catalyst carrier is modified with an acidic functional group, the Hammett acidity function is defined as −3 or less, whereby high I-V properties are imparted to a fuel cell using such a catalyst.

A third aspect of the present invention is defined as follows: the catalyst for a fuel cell as defined in the second aspect, wherein the acidic functional group is a sulfonic acid group.

The sulfonic acid group is firmly covalently bonded to the catalyst carrier, and is hard to detach as compared with other acidic functional groups. The use of the sulfonic acid group which is firmly bonded to the carrier in the catalyst for a fuel cell exposed to drastic environmental changes such as temperature and humidity changes provides stable catalyst performance and improvement in its durability.

A fourth aspect of the present invention is defined as follows:

a method for producing a catalyst for a reaction layer of a fuel cell, including:

modifying a carrier with a sulfonic acid group so that the Hammett acidity function is −3 or less.

The production method as defined in the third aspect in this manner ensures the production of the catalyst for a fuel cell as defined in the third aspect.

A fifth aspect of the present invention is defined as follows:

the production method as defined in the third aspect, wherein a modification of the carrier with a weakly-acidic functional group is followed by substitution of the weakly-acidic functional group by the sulfonic acid group.

According to the production method of a catalyst for a fuel cell as defined in the fifth aspect in this manner, the carrier is modified with the acidic functional groups in two separate stages, and thus can be modified with the sulfonic acid group without imparting great stress to the catalyst carrier, in other words, while maintaining the properties of the carrier.

### BRIEF DESCRIPTION OF THE DRAWINGS

FIG. 1 is a graph showing the evaluation results of the binding force of an acidic functional group to a catalyst.

FIG. 2 is a graph showing the relation between the Hammett acidity function and the IV properties of a fuel cell.

FIG. 3 is a schematic view illustrating the PFF structure corresponding to FIG. 4B.

FIG. 4 is a schematic view showing the form of an electrolyte in an electrolyte solution in the cases where the moisture concentration of the electrolyte solution is high FIG. 4A and low FIG. 4B.

FIG. 5 is a schematic view illustrating the PFF structure corresponding to FIG. 4A.

FIG. 6A shows the relation between the time for stirring a prepaste and an electrolyte solution and the viscosity, and FIG. 6B shows the relation between similarly the stirring time and the reaction layer resistance.

FIG. 7 is a schematic view of an apparatus for producing a catalyst paste.

FIG. 8 is a graph showing the I-V properties of a fuel cell using a catalyst according to Example of the present invention.

### MODES FOR CARRYING OUT THE INVENTION

In the present invention, an acidic functional group is covalently bonded to a carrier of a catalyst for a fuel cell for modification of this carrier. The inner peripheral surfaces of the micropores in the carrier and the faces exposed to the gaps among the catalyst particles are also modified with an acidic functional group. Especially in the PFF structure, the inside of an electrolyte membrane which covers the catalyst is filled with the generated water, so that the micropores in the carrier and the gaps among the catalyst particles are also filled with water. Thus, even if an electrolyte cannot get into the micropores and gaps, protons are released from the acidic functional group into water, so that the catalyst metal particles exposed to the inner peripheral surfaces of the micropores and the gaps can contribute to a fuel cell reaction.

Examples of the acidic functional group can include one or two or more of a hydroxyl group, a carboxyl group, a carbonyl group, a sulfonic acid group, a nitro group, a nitric acid group, a nitrous acid group, and a phosphate group. When the carrier is modified with these acidic functional groups, protons are released from these groups, thereby activating the catalyst metal particles exposed to the inner peripheral surfaces of the micropores and gaps in the catalyst.

Because the acidic functional group is used in a catalyst for a fuel cell which undergoes drastic environmental changes, a sulfonic acid group having strong binding force with the carrier is preferably employed from the viewpoint of ensuring the stability and durability of the catalyst.

(evaluation of Binding Force of Sulfonic Acid Group)

A catalyst A in which 40% of platinum was supported on a carbon carrier modified with a sulfonic acid group and a catalyst B in which 40% of platinum was supported on a carbon carrier modified with a nitric acid group and a nitrous acid group were each subjected to hot water extraction at 120° C. for 10 hours. Sulfur and nitrogen contained in the catalyst before and after the extraction treatment were quantitatively analyzed to obtain the rates of the functional groups remaining in the respective catalysts.

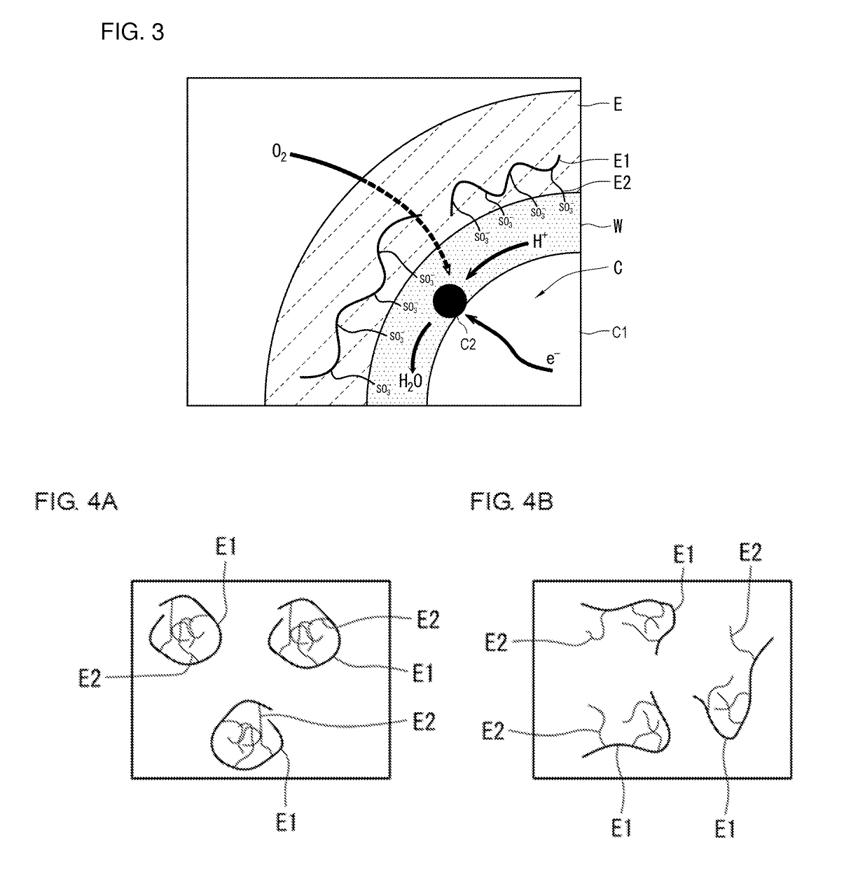

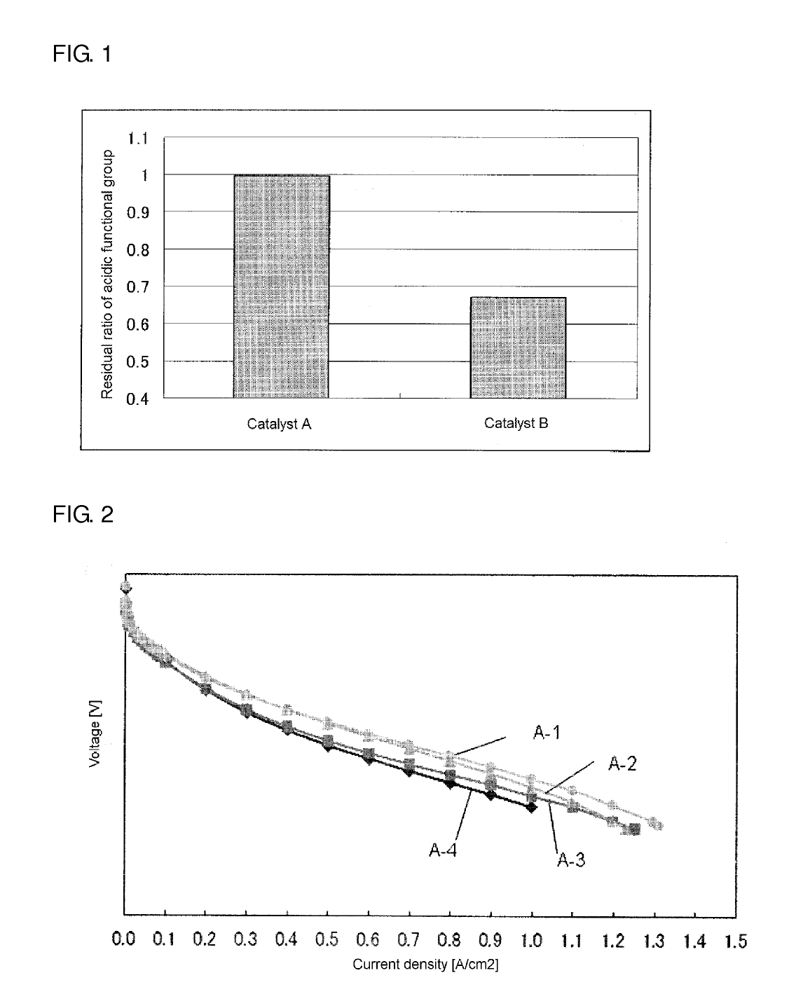

The results are shown in FIG. 1.

From the results shown in FIG. 1, it has been found that no sulfonic acid group is detached in the catalyst A, but that the residual rate for the catalyst B is 67%, and that 33% of the nitric acid groups (or nitrous acid groups) are eluted into hot water and detached from the carrier.

The catalyst A of Examples was prepared as follows.

(preparation of Catalyst Carrier Modified with Sulfonic Acid Group)

The following steps (1) to (8) were carried out to modify a catalyst carrier with a sulfonic acid group:

(1) pretreatment: adding 100 mL of 35% hydrogen peroxide water to 1 g of carrier carbon, wet-pulverizing the mixture in a bead mill for 30 min., thereafter adding 100 mL of 35% hydrogen peroxide water to the slurry, and stirring it at room temperature for 48 h.;

(2) filtering the slurry after stirring, newly adding 150 mL of 35% hydrogen peroxide water, and stirring it at room temperature for 48 h.;

(3) filtering the slurry again, newly adding 150 mL of 35% hydrogen peroxide water, and stirring it at room temperature for 48 h.;

(4) vacuum-drying the carbon carrier at 120° C. for 12 h. after filtration;

(5) warming the carbon carrier in step (4) up to 60° C. in 200 mL of 20% fuming sulfuric acid and stirring the mixture for 10 h.;

(6) after filtering and washing with 1 L of hot water at 80° C., vacuum-drying the carrier at 120° C. for 12 h.;

(7) removing an extra acid by Soxhlet extraction for 8 h.; and

(8) vacuum-drying the carrier at 120° C. for 12 h.

(supporting of Platinum Catalyst Fine Particles)

The following steps (A) to (F) are applied to a catalyst carrier modified with a sulfonic acid group to support platinum catalyst fine particles:

(A) adding 13 mL of a 10% aqueous chloroplatinic acid solution and 10 mL of a 20% aqueous KOH solution to 600 cc of ethylene glycol and stirring the mixture for 24 h.;

(B) adding 1 g of a catalyst carrier modified with a sulfonic acid group thereto and stirring the mixture for 24 h.;

(C) heating the slurry in step (B) with 1000-W microwave for 5 minutes and cooling it with ice water;

(D) filtering the slurry in step (C) and washing it with acetone;

(E) washing the residue catalyst with pure water; and

(F) vacuum-drying the catalyst in step (E) at 120° C. for 12 h.

Thus, the catalyst A is prepared.

The catalyst B of Comparative Example is prepared as follows.

(preparation of Catalyst Carrier Modified with Nitric Acid Group or Nitrous Acid Group)

The following steps (1) to (9) were carried out to modify a catalyst carrier with a sulfonic acid group:

(1) pretreatment: adding 100 mL of 35% hydrogen peroxide water to 1 g of carrier carbon, wet-pulverizing the mixture in a bead mill for 30 min., thereafter adding 100 mL of 35% hydrogen peroxide water to the slurry, and stirring it at room temperature for 48 h.;

(2) filtering the slurry after stirring, newly adding 150 mL of 35% hydrogen peroxide water, and stirring it at room temperature for 48 h.;

(3) vacuum-drying the carrier at 120° C. for 12 h. after filtration;

(4) adding 12 g of water to 1 g of the carbon carrier in step (3) and centrifugally stirring the mixture in a hybrid mixer for 4 min.;

(5) adding 88 g of water thereto and treating the mixture in an ultrasonic homogenizer for 10 min.;

(6) diluting a hexahydroxo Pt acid nitric acid solution (Pt: 10 wt % and nitric acid concentration: 50 wt %) 300 times with pure water, and adding the product in step (5) thereto;

(7) stirring the mixture with a stirrer for 4 hours;

(8) after filtration and washing with pure water, vacuum-drying the product at 60° C. for 3 h.; and

(9) heating the product in an N2 flow at 150° C.

The method for supporting platinum catalyst fine particles is similar to that employed for the catalyst A of Example described above.

(evaluation of Hammett Acidity Function)

Sulfonic acid group-modified catalysts having different Hammett acidity functions (Table 1) were used to prepare catalyst layers, and power generation evaluation of MEAs using them as cathodes were made under low-humidity conditions (temperature: 80° C.; humidity: 4% RH; and pressure: atmospheric pressure).

TABLE 1

| Catalyst | Hammett acidity function |
|---|---|
| A-1 | −4.7 |
| A-2 | −3.3 |
| A-3 | −0.7 |
| A-4 | 2.4 |

The adjustment of the Hammett acidity function was carried out by controlling steps (1) to (3) when the catalyst carriers were modified with sulfonic acid groups.

Specifically, a catalyst A-1 is obtained by carrying out the above-described steps (1) to (8). When step (3) is omitted, a catalyst A-2 is obtained. When steps (2) and (3) are omitted, a catalyst A-3 is obtained. A catalyst A-4 is obtained by carrying out step (1) at 40° C. and omitting steps (2) and (3).

The results are shown in FIG. 2.

As shown in FIG. 2, the I-V performance was better as the Hammett acidity function was negatively larger. In the power generation performance ranging from 0.1 A/cm² to 0.8 A/cm², A-1 and A-2 were higher in performance than A-3 and A-4. This is considered to be because catalysts which are not coated with an ionomer also ensure sufficient proton conductivity due to the sulfonic acid groups present on the carrier, and can maintain power generation also under the low-humidity conditions so that wetting is kept by the generated water.

Further, this is also considered to be because the sulfonic acid groups are per se hydrophilic, and thus have strong affinity for water, and also have the effect of suppressing evaporation of the generated water.

The Hammett acidity function described above is a scale which represents the intensity of an acid used when the hydrogen ion index (pH) cannot be applied, for example, in the case of solid acids, high-concentration solutions, mixed solvent systems, superacids, and the like. Sulfonated porous carbon is a solid acid, and thus its intensity as an acid is properly represented by the Hammett acidity function, which is a useful scale when it is evaluated as an acid catalyst.

In this example, the argon adsorption heat was measured and converted to the Hammett acidity function using an empirical formula, based on the method of Matsuhashi et al. (H. Matsuhashi et al., J. Phys. Chem. B. 105, 9669 (2001)).

Catalyst layers when the results shown in FIG. 2 are obtained are prepared as follows.

The following steps (a) to (f) are carried out to prepare catalyst pastes:

(a) adding 6 g of water to 0.5 g of a catalyst (Pt: 50 wt %) and centrifugally stirring the mixture in a hybrid mixer for 4 min.;

(b) adding 90 g of water thereto, and treating the mixture in an ultrasonic homogenizer for 10 min.;

(c) allowing the product to stand for 1 hour or longer to precipitate a catalyst, and removing the supernatant;

(d) removing the supernatant in such a manner that the catalyst:water ratio of the above-described prepaste is 1:12;

(e) warming and removing the solvent of a polymer electrolyte solution (DE2020), and dissolving the polymer in a solution having an IPA:TBA ratio of 1:1 again to prepare a 5% solution; and

(f) adding 5 g of the polymer electrolyte solution in step (e) to the catalyst+water paste in step (d) and mixing and stirring them in a hybrid mixer for 4 min.

The catalyst pastes obtained by carrying out the above-described steps are applied to GDL by screen printing, and then dried with hot air.

The thus-obtained electrodes and electrolyte membranes are thermally press-bonded at 140° C. and 40 kgf/cm².

Hereinafter, the PFF structure is explained.

The PFF (the Applicant's registered trademark) structure used herein means a structure in which hydrophilic functional groups in the side chain of a polymer electrolyte are oriented to the side of a catalyst in order to form a hydrophilic layer on the catalyst.

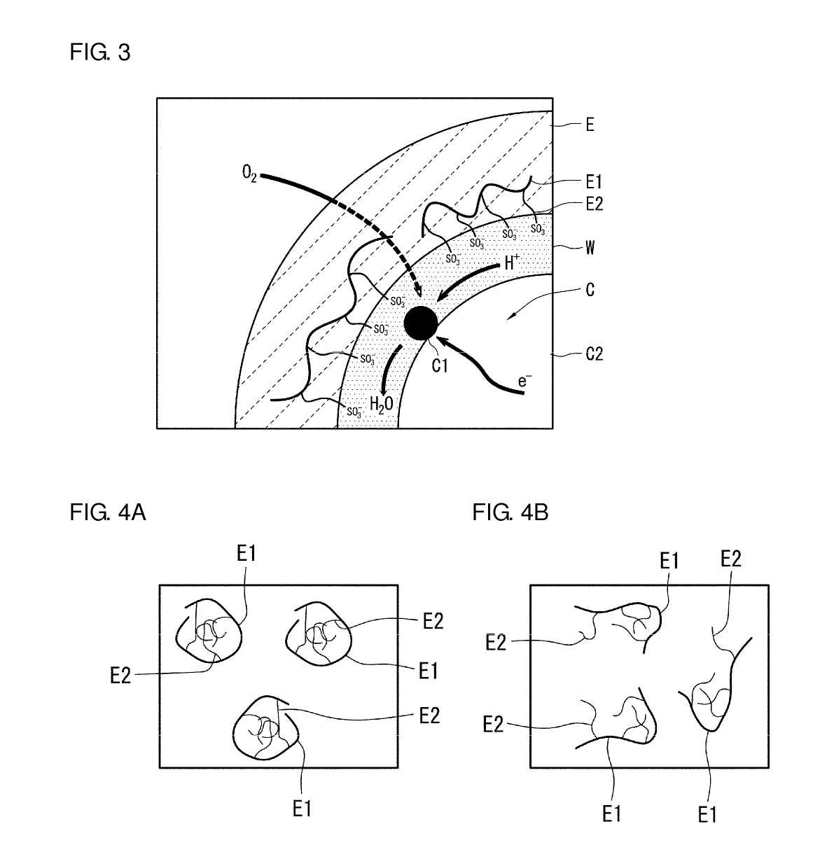

For example, in perfluorosulfonic acid (for example, Nafion, registered trademark of Du Pont) generally used as a polymer electrolyte, sulfonic acid groups (—SO₃⁻) as hydrophilic functional groups are bound as a side chain E2 to a hydrophobic main chain E1, and, as shown in FIG. 3, these hydrophilic functional groups are oriented to the side of a catalyst C so that continuous hydrophilic regions W are formed between the catalyst C and an electrolyte layer E. In the agglomerated catalyst C, the hydrophilic regions W on the surfaces of the respective catalyst particles are communicated with each other. Protons (H⁺) and water (H₂O) can smoothly move in the hydrophilic regions W of the PFF structure, resulting in promotion of an electrochemical reaction of a fuel cell.

Also, according to the PFF structure, since water gathers around the catalyst C, even a small amount of water mostly contributes effectively to the electrochemical reaction, thereby making it possible to prevent the reduction in power generating ability of the fuel cell also in a low-humidity state. On the other hand, the continuous hydrophilic regions W function as a drainage path for excessive water, so that flooding phenomena can be prevented even in a high-humidity state.

The catalyst C described above means a catalyst in which catalyst metal particles C2 are supported on a carrier C1 having conductivity. The carrier C1 is required to have conductivity and air permeability, and can employ porous carbon black particles, but tin oxide, titanic acid compounds, and the like can also be used. The catalyst metal particles C2 consist of metal fine particles which can provide an active site of the fuel cell reaction, and noble metals such as platinum, cobalt, and ruthenium and alloys of the noble metals can be used.

A method for supporting the catalyst metal particles C2 on the carrier Cl can be appropriately selected from well-known methods such as an impregnation method, a colloid method and a precipitative sedimentation method according to the materials for them and the intended use of the catalyst.

### (Treatment of Catalyst)

Normally, the catalyst is provided from a catalyst maker. This catalyst is preferably physically and/or chemically treated according to, for example, the properties required for a fuel cell.

### (Physical Treatment of Catalyst)

The physical treatment of the catalyst includes pulverizing treatment and defoaming treatment.

### —Pulverizing Treatment—

Generally, catalysts are such that their carriers are agglomerated to form secondary or tertiary particles. In order to improve the surface area of the catalyst, the agglomerate is preferably pulverized into fine powder. For that purpose, the agglomerate of the catalyst is preferably dispersed into a medium for wet pulverization.

Wet pulverization ensures application of higher energy to the catalyst agglomerate so that the agglomerate can be pulverized more finely when compared with dry pulverization. Also, wet pulverization can effectively prevent rebinding of the catalyst as compared with dry pulverization. As the method for wet pulverization, a homogenizer, a wet jet mill, a ball mill or a bead mill can be employed.

The effect of eliminating the impurities attached to the catalyst carrier is also obtained by employing wet pulverization. Although water is generally used as a medium, other media (such as an organic solvent) can also be employed according to the properties of the impurities. It is also possible to firstly carry out wet pulverization using water as a medium and then to remove impurities from the catalyst, for example, with an organic solvent.

In order to dry the wet-pulverized catalyst, the medium is preferably removed by sublimation. This can prevent reagglomeration of the catalyst. Examples of the method for sublimating the medium include a vacuum drying method. In contrast to this, in the case where a heat-drying method is employed, when the medium is moved upon heating or evaporated, a capillary contraction phenomenon occurs and causes rebinding of the catalysts, so that the highly-dispersed state obtained by wet drying cannot be maintained.

It is also possible to carry out wet pulverization and, according to need, impurity removal to the catalyst carrier so that the catalyst metal particles are supported on its carrier in the state where the carrier is dispersed in the medium (for example, water). Also in this case, the medium in which the catalyst is dispersed is preferably removed by sublimation, as the drying step.

### —Defoaming Treatment—

Air babbles are preferably removed from the periphery of the catalyst (defoaming treatment) in the state where the catalyst is mixed and dispersed in water. This is because the air bubbles interfere with the formation of a hydrophilic region between the catalyst and the electrolyte layer.

This defoaming treatment can be carried out by using a centrifugal stirring method with a hybrid mixer (rotation/revolution centrifugal stirrer).

Of course, the method is not limited to the centrifugal stirring method, and any other stirring methods (such as a ball mill method, a stirrer method, a bead mill method, and a roll mill method) can also be used.

Air bubbles can sometimes be removed from the periphery of the catalyst during wet pulverization, and, in that case, independent defoaming treatment is unnecessary.

### (Chemical Treatment of Catalyst)

The catalyst is chemically treated to modify the surface of its carrier with a specific hydrophilic group.

Modification of the carrier surface with a hydrophilic group improves hydrophilicity around the carrier and enhances the hydrophilicity of the hydrophilic region W between the catalyst C and the electrolyte layer E.

Here, the modification means that the modification group is present on the carrier surface and is not separated therefrom even through normal production steps.

As the hydrophilic group, at least one selected from nitro groups, nitric acid groups, nitrous acid groups, amino groups, sulfonic acid groups, phosphate groups, hydroxyl groups, and halogen groups can be indicated. More preferably, at least one selected from nitro groups and sulfonic acid groups can be indicated as the hydrophilic group.

Due to the presence of these hydrophilic groups around the carrier, a hydrophilic region is easily formed around the carrier. The catalyst metal particles are homogenously dispersed on the carrier, and, as a result, the hydrophilic region on the surface of the catalyst is easily formed, and, after formed, is stabilized.

In the present invention, a method for modifying the catalyst metal particles with the above-described hydrophilic group involves binding, to the above-described catalyst metal particles, a complex of a metal (noble metal) which is the same as the catalyst metal particles or is of the same kind as the catalyst metal particles and which includes the above-described modification group. The complex can be utilized to modify the catalyst metal particles with the hydrophilic group without giving any stress to the catalyst structure.

When platinum or a platinum alloy is employed as the catalyst metal particles, modification is preferably carried out by using the following platinum complex solution. As such platinum complex solutions, the following solutions are considered usable: an aqueous solution of chloroplatinic (IV) acid hydrate (H₂PtCl₆.nH₂O/H₂O sol.), a hydrochloric acid solution of chloroplatinic (IV) acid (H₂PtCl₆/HCl sol.), an aqueous ammonium solution of chloroplatinic (IV) acid ((NH₄)₂PtCl₆/H₂O sol.), an aqueous solution of dinitro diamine platinum (II) (cis-[Pt(NH₃)₂(NO₂)₂]/H₂O sol.), a nitric acid solution of dinitro diamine platinum (II) (cis-[Pt(NH₃)₂(NO₂)₂]/HNO₃ sol.), a sulfuric acid solution of dinitro diamine platinum (II) (cis-[Pt(NH₃)₂(NO₂)₂]/H₂SO₄ sol.), an aqueous solution of potassium tetrachloroplatinate (II) (K₂PtCl₄)/H₂O sol.), an aqueous solution of platinum (II) chloride(PtCl₂/H₂O sol.), an aqueous solution of platinum (IV) chloride (PtCl₄/H₂O sol.), an aqueous solution of tetraammine platinum (II) dichloride hydrate ([Pt(NH₃)₄]Cl₂.H₂O/H₂O sol.), an aqueous solution of tetraammine platinum (II) hydroxide ([Pt(NH₃)₄](OH)₂/H₂O sol.), an aqueous solution of hexaammine platinum (IV) dichloride ([Pt(NH₃)₆]Cl₂/H₂O sol.), an aqueous solution of hexaammine platinum (IV) hydroxide ([Pt(NH₃)₆](OH)₂/H₂O sol.), an aqueous solution of hexahydroxoplatinic (IV) acid (H₂[Pt(OH)₆]/H₂O sol.), a nitric acid solution of hexahydroxoplatinic (IV) acid (H₂[Pt(OH)₆]/HNO₃ sol.), a sulfuric acid solution of hexahydroxoplatinic (IV) acid (H₂[Pt(OH)₆]/H₂SO₄ sol.), a solution of ethanolamine platinum (H₂[Pt(OH)₆]/H₂NCH₂CH₂OH sol.), and the like.

According to the inventors' finding, a nitro group is preferably selected as the hydrophilic group with which the catalyst metal particles consisting of platinum or a platinum alloy are modified. As the platinum complex solution for that purpose, the following solutions can be employed: a nitric acid solution of dinitro diamine platinum (II) (cis-[Pt(NH₃)₂(NO₂)₂]/HNO₃ sol.) and a nitric acid solution of hexahydroxoplatinic (IV) acid ((H₂Pt(OH)₆)/HNO₃ sol.) each having NO₃⁻ as a hydrophilic ion, a sulfuric acid solution of hexahydroxoplatinic (IV) acid having SO₄²⁻ as a hydrophilic ion ((H₂Pt(OH)₆)/H₂SO₄ sol.), an aqueous solution of tetraammine platinum (II) hydroxide having NH₄⁺ as a hydrophilic ion ([Pt(NH₃)₄(OH)₂]/H₂O sln.), and the like.

The method for modifying the catalyst metal particles with the hydrophilic group can be appropriately selected according to the properties of the catalyst metal particles and hydrophilic group. However, for example, when the catalyst metal particles are made of platinum or a platinum alloy, it is sufficient to mix the catalyst with a platinum complex solution and to stir the solution according to need. When a nitro group is selected, the starting material catalyst is introduced into an aqueous nitric acid solution of dinitro diamine platinum (complex), and the solution is stirred so that the platinum complex (dinitro diamine platinum) is adsorbed onto the catalyst platinum particles of the starting material catalyst. Also, the aqueous nitric acid solution of dinitro diamine platinum (complex) may be added and stirred in the state where the starting material catalyst is dispersed in water. Here, the stirring is not limited to mechanical stirring with a blade or stirrer, and can also be carried out by distributing two solutions through one pipeline.

In the meantime, heating treatment is preferably carried out in order to stabilize the binding between the hydrophilic group and the catalyst metal particles.

When platinum particles are used as the catalyst metal particles, the nitric acid ions (NO₃⁻) adsorbed thereon are preferably reduced to nitro groups (—NO₂). The reduction method is not particularly limited, but it is sufficient to heat a catalyst having catalyst platinum particles on which nitric acid ions are adsorbed in an inert atmosphere. Even when strong force is applied to the catalyst subjected to such stabilizing treatment by physical treatment with a homogenizer or the like, the hydrophilic group is not detached from the catalyst metal.

### (Order of Physical Treatment and Chemical Treatment Applied to Catalyst)

In order to effectively modify the catalyst metal particles in the catalyst with the hydrophilic group, physical treatment is preferably carried out prior to chemical treatment. This is because the physical treatment of the catalyst loosens the agglomeration of the catalyst particles, whereby more catalyst metal particles can be brought in contact with a treatment liquid containing hydrophilic groups. Further, the physical treatment causes defoaming of air, i.e., removes an air layer covering over the catalyst surface, whereby more catalyst metal particles can be brought in contact with a treatment liquid containing hydrophilic groups also in this regard.

When the catalyst is likely to reagglomerate due to chemical treatment, physical treatment is preferably carried out again after the chemical treatment.

Of course, the catalyst may also be subjected firstly to chemical treatment and then to physical treatment.

### (Preparation of Prepaste)

The moisture amount of a prepaste obtained by dispersing a catalyst in water is controlled.

In order to cause the hydrophilic groups of an electrolyte to face the surface of the catalyst to obtain a hydrophilic region between the electrolyte and the catalyst, the catalyst and water are mixed together to form a water layer on the surface of the catalyst in advance (step for hydrophilizing catalyst).

While the mixing ratio between the catalyst and water should be appropriately selected depending on the kind of the catalyst (especially, kind of the carrier of the catalyst and grain size), according to the present inventors' reviews, the mixture (prepaste) of the catalyst and water is preferably in a moisture state (fluidity limit) where the mixture changes from a capillary state (the mixture has no fluidity although water is present on the entire periphery of the catalyst particles) to a slurry state (the mixture has fluidity while water is present on the entire periphery of the catalyst particles) and in a moisture state near this state. Such a moisture amount becomes an optimum amount such that continuous hydrophilic regions can be formed between the catalyst and the electrolyte while the surface of the catalyst is hydrophilized.

Here, the flow limit means a limit of moisture content at which the mixture changes from the capillary state to the slurry state and starts to flow.

In the relation between the shear rate and viscosity of the prepaste, in the case where an approximate straight line at the time when the viscosity is plotted to the shear rate in a double logarithmic manner is obtained, the flow limit is a paste state where the slope of the approximate straight line is −1, and the slurry state is a paste state where the slope of the approximate straight line is −0.8.

The slope of the approximate straight line in the relation between the shear rate and viscosity becomes −1 or more, i.e., gentle, and the prepaste is in a slurry state with high fluidity. Since the state where the prepaste contains excessive moisture causes deterioration in performance of MEA, the optimum amount is an amount of water to be added which allows the paste to change from the flow limit to the slurry state, i.e., which gives a slope ranging from −1 to −0.8. An ideal prepaste can thus be obtained. It is important for the prepaste to define the minimum necessary amount of moisture to be added by the slope of this approximate straight line. On the other hand, the fluidity of the mixture is lost in the capillary state where the slope is less than −1 (the slope is steep), and thus more energy is required during mixing, and water and the catalyst are likely to be insufficiently stirred. Therefore, this is not suitable as the condition for obtaining a suitable prepaste.

Since water is present around the catalyst also when the amount of moisture is more than the above-described optimum amount, the catalyst surface can be hydrophilized. However, such excessive moisture is likely to interfere with construction of the PFF structure when the prepaste is mixed with an electrolyte solution (pre-solution). Excessive water leaves the catalyst, and attracts the hydrophilic groups of the electrolyte in a region distant from the catalyst. Accordingly, the hydrophilic groups of the electrolyte facing the catalyst are decreased, so that the hydrophilic region to be formed between the catalyst and the electrolyte would become narrow or would be separated, and that the hydrophilic function in the region would be deteriorated (the water retaining force would be deteriorated).

When the catalyst is wet-pulverized in water, the catalyst is dispersed in a large amount of water. Here, the amount of water is preferably 5 folds to 100 folds by weight with respect to the catalyst. Thereafter, moisture is removed to ensure an amount of moisture suitable as a prepaste. For example, a method of using a hot-water bath or the like can be employed for removal of moisture.

### (Preparation of Electrolyte Solution)

The perfluorosulfonic acid described above is commonly used as the electrolyte. This electrolyte is dissolved in a solvent mixture of water and an organic solvent, and mixed with the prepaste described above.

The organic solvent is appropriately selected depending on the properties of the electrolyte, but is preferably at least one of secondary and tertiary alcohols according to the present inventors' reviews. A primary alcohol such as methanol or ethanol cannot make the viscosity of the electrolyte solution high even if the moisture concentration is lowered. When a secondary alcohol such as isopropyl alcohol (IPA) or a tertiary alcohol such as tertiary butyl alcohol (TBA) is mixed, the solid content of the electrolyte in the electrolyte solution would be brought in a looser state. Also, according to the present inventors' reviews, when a secondary alcohol and a tertiary alcohol are mixed, the solid content of the electrolyte in the electrolyte solution would be brought in a further looser state.

As a result of the reviews on the optimization of the electrolyte solution used in the PFF structure described above, the present inventors have found that the optimum amount of moisture to be contained in the electrolyte solution is 10% by weight or less, more preferably 5% by weight or less of the electrolyte solution.

The following relation is established between the electrolyte and the moisture amount.

It has been found that the decrease in concentration of moisture in the electrolyte solution causes an increase in viscosity of the electrolyte solution also in the case where the concentration of the electrolyte in the electrolyte solution is identical, and that, conversely, the increase in moisture concentration causes a decrease in viscosity of the electrolyte solution. The reason for this is inferred as follows.

That is, it was inferred that, at a high concentration of moisture contained in the electrolyte solution, water is adsorbed on the side chains E2 of the electrolytes, and that the main chains E1 of the electrolytes shrink in the electrolyte solution so that the electrolytes are brought in a separated state, as shown in FIG. 4A, thereby lowering the viscosity of the electrolyte solution. Also, when the concentration of moisture of the electrolyte solution becomes slightly low, due to the action of the organic solvent contained in the electrolyte solution, the main chains E1 of the electrolytes open in the electrolyte solution as shown in FIG. 4B, and become easy to mutually entangle, thereby increasing the viscosity of the electrolyte solution.

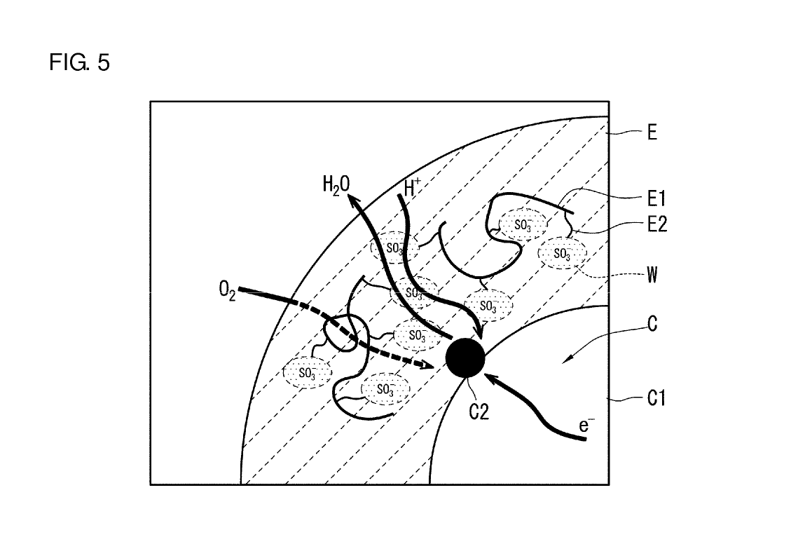

When the electrolyte solution is mixed in the electrolyte (FIG. 4A) state to form a reaction layer, a state as shown in FIG. 5 is considered to be established in this reaction layer. That is, the main chains of the electrolytes shrink and the electrolytes are separated from each other, and thus mixing thereof with the prepaste increases the probability of causing formation of hydrophilic regions W in a dispersed state.

In other words, in order to cause the hydrophilic side chain E2 of the electrolyte to face the catalyst to reliably form a hydrophilic region between them, the electrolyte in the electrolyte solution is preferably brought in the state as shown in FIG. 4B. For that purpose, the amount of moisture contained in the electrolyte solution is defined as 10% by weight or less of the electrolyte solution.

When the electrolyte in the state shown in FIG. 4B is used, the cathode catalyst layer is considered to be in the state shown in FIG. 3.

The side chain E2 of the electrolyte is in an extending state in one direction, and thus a hydrophilic ion exchange group (sulfonic acid group (also referred to as sulfo group)) adsorbs water in the prepaste in the catalyst paste, namely, reaction layer for a fuel cell. Therefore, as shown in FIG. 3, this reaction layer is brought in a state where the hydrophilic group E2 of the electrolyte is opposite to the surface of the catalyst C, so that a hydrophilic region W is formed between the electrolyte layer E and the catalyst C. It is considered that the sulfonic acid group adsorbs water in the prepaste as described above, so that hydrophilic regions W are continuously formed around the catalyst C, and formed in a mutually communicated state. Therefore, in the reaction layer using this catalyst paste, protons and water easily move as shown in FIG. 3, so that an electrochemical reaction is smoothly progressed. A fuel cell having such a reaction layer can enhance the power generating ability both in a low-humidity state and in an excessively humidity state.

The amount of moisture contained in the electrolyte solution is attained by evaporating water from the electrolyte solution, for example, by heating it in a hot-water bath and then appropriately adding water.

When water is evaporated from the electrolyte solution, the organic solvent contained in the solution is also volatilized. Thus, the organic solvent is also added according to need.

### (Mixing of Prepaste and Electrolyte Solution)

A catalyst paste is obtained by mixing a prepaste and an electrolyte solution.

The prepaste provided in the above-described manner is near the fluidity limit, and thus has high viscosity. Also, the viscosity of the above-described electrolyte solution is higher as the water content contained therein is smaller.

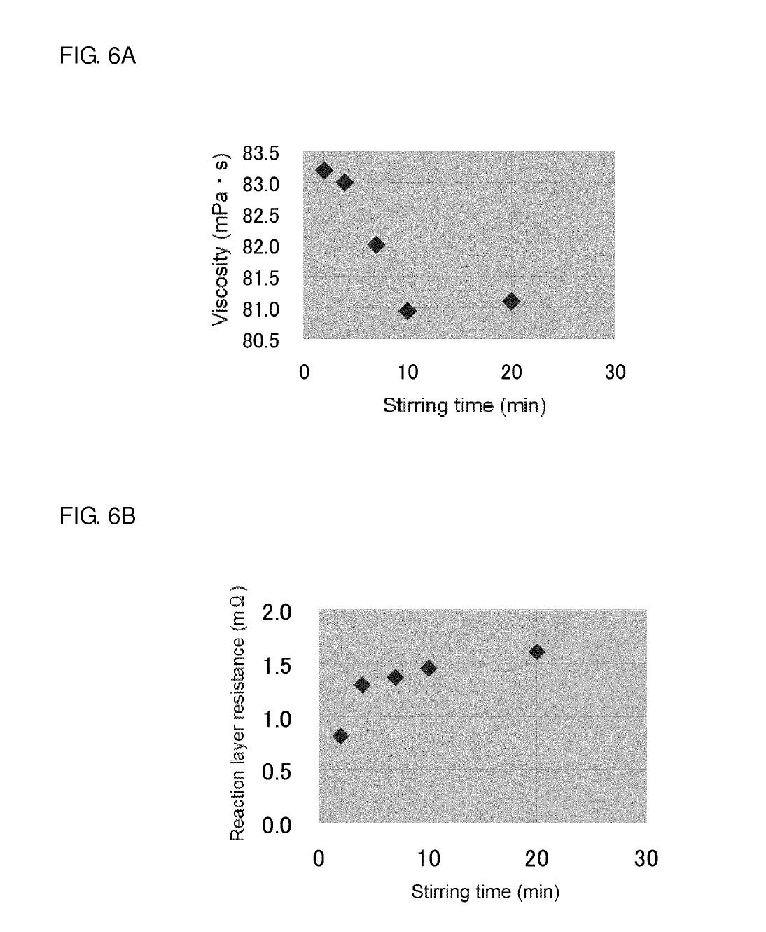

By mixing and stirring the prepaste and electrolyte solution both which have been obtained under the conditions for increasing the viscosity, the viscosity of the mixture lowers over time, and thereafter becomes stable at a certain value, as shown in FIG. 6A.

The present inventors have focused on such viscosity behavior of the prepaste/electrolyte solution mixture when stirred.

FIG. 6B shows the relation between the stirring time (=viscosity) and the reaction layer resistance.

The catalyst paste obtained by changing the stirring time (=viscosity) was used to constitute a fuel cell, and the impedance of the reaction layer was measured.

It can be seen from FIGS. 6A and 6B that, when the viscosity is lowered by stirring, the impedance of the reaction layer becomes high in inverse proportion thereto. The increase in impedance means reduction in movement of protons in the reaction layer.

It can be understood from the above that, when a catalyst paste is prepared by mixing a prepaste and an electrolyte solution, stirring is preferably quickly carried out to complete uniform mixing of them before reduction and stabilization of the viscosity of the mixture. In other words, when the prepaste and electrolyte solution are stirred, the viscosity of the mixture of them is monitored, and stirring is stopped before stabilization of its viscosity at a low level.

When the prepaste/electrolyte solution mixture is stirred, the periphery of the catalyst of the prepaste is covered with the electrolyte. At this time, the electrolyte in the open state as shown in FIG. 4B causes its hydrophilic group to be oriented so as to face the catalyst to construct the PFF structure. However, when stirring is carried out also after construction of the PFF structure (hereinafter sometimes referred to as “excessive stirring”), the electrolyte which faces the catalyst is separated from the catalyst, deprives the catalyst of water on the surface thereof at that time, and is detached from the surface. The electrolyte detached from the catalyst surface is accompanied by water on the catalyst surface, and thus easily takes the form shown in FIG. 4A. Therefore, it is considered that the viscosity of the electrolyte solution component in the catalyst paste lowers, thereby causing the reduction in viscosity of the catalyst paste itself. Also, the detachment of the electrolyte from the catalyst surface weakens the PFF structure so that the function of the hydrophilic region formed between the catalyst and the electrolyte is deteriorated. It is predicted that this causes the rise in reaction layer resistance.

The viscosity of the mixture of the prepaste and the electrolyte solution is adjusted to a predetermined viscosity. This can prevent excessive stirring of them. That is, since the viscosity of the excessively-stirred mixture is lowered as described above, the excessive stirring of the mixture can be prevented by stopping stirring when the viscosity of the mixture exhibits a predetermined behavior. A stable PFF structure can always be constructed by preventing excessive stirring.

While a rotation/revolution centrifugal stirrer is preferably used for mixing and stirring of the prepaste and the electrolyte solution, a ball mill, a bead mill, a stirrer, a homogenizer, and the like being common and having mixing and stirring functions can also be employed.

The viscosity of the prepaste/electrolyte solution mixture varies depending, for example, on the materials for them, mixing ratio between them, and, further, environmental temperature. Therefore, the viscosity of the mixture would be monitored to detect and evaluate the behavior thereof (not an absolute value of viscosity).

The behavior of the viscosity of the mixture refers to a temporal change in viscosity before the mixture viscosity has been stabilized at a low level. For example, the lowering rate of the viscosity per unit time, lowering rate of the viscosity to the initial viscosity, and the like can be employed.

As is evident from FIG. 6A, when the time for stirring the mixture exceeds a constant time (4 minutes in the example shown in FIG. 6A), the proportion of reduction in viscosity per time is increased. Thus, stirring can be stopped at the time when the proportion of reduction in viscosity of the mixture which is caused by stirring exceeds a predetermined value.

In the management of the viscosity in the steps of producing a catalyst paste, the rotation rate of a hybrid mixer is preferably kept constant. Further, stirring is preferably carried out under a constant temperature.

For more precise viscosity management, the viscosity of the mixture can also be measured in real time during stirring. For example, mixing of the prepaste and the electrolyte solution can also be carried out by using a rotor rotation controlled viscometer simultaneously with measurement of the viscosity. Also, applicable is a method involving using a bead mill, a homogenizer or the like for mixing of the prepaste and the electrolyte solution and incorporating a viscometer capable of measuring the viscosity in real time, such as a tuning-fork vibration type viscometer, in a paste circulating line.

Stirring and viscosity measurement are preferably carried out under a constant temperature in any method.

### (Formation of Reaction Layer)

The catalyst paste obtained in the above-described manner is applied to a gas diffusion substrate to form a reaction layer. A carbon cloth, a carbon paper, a carbon felt, and the like can be employed as the gas diffusion substrate. A water-repellent layer is preferably formed on the surface of the gas diffusion substrate (face on the reaction layer side). This water-repellent layer can be formed from carbon black treated with PTFE to be water repellent. Any method including screen printing, spraying, ink jetting, and the like can be employed as the method for applying the catalyst paste.

In the above-described procedures, the reaction layer employing a catalyst paste having low viscosity can be provided, for example, in a portion where flooding of an electrode easily occurs, for example, near an air outlet, near a hydrogen outlet, in the outer peripheral part of the electrode, and near a cooling plate. Due to this, the catalyst stably exhibits high performance even in a high humidity atmosphere.

The reaction layer using a catalyst paste with high viscosity may also be provided in a portion where the electrode is easily dried, for example, near an air inlet, near a hydrogen inlet, in the electrode center portion, and at a site distant from the cooling plate. Due to this, the catalyst stably exhibits high performance even in a low humidity atmosphere.

An air electrode (gas diffusion substrate+reaction layer) and a hydrogen electrode (gas diffusion substrate+reaction layer) are formed by repeating application of the catalyst paste to the gas diffusion substrate and drying thereof in a predetermined number of times. These air and hydrogen electrodes sandwich a solid polymer electrolyte membrane therebetween, and they are bonded together, for example, by hot press, thereby obtaining a membrane electrode assembly (MEA). This membrane electrode laminate is sandwiched between separators so that a fuel cell as a minimum power generation unit is constructed.

The method for producing the catalyst paste and the materials used in the production has been exclusively explained above.

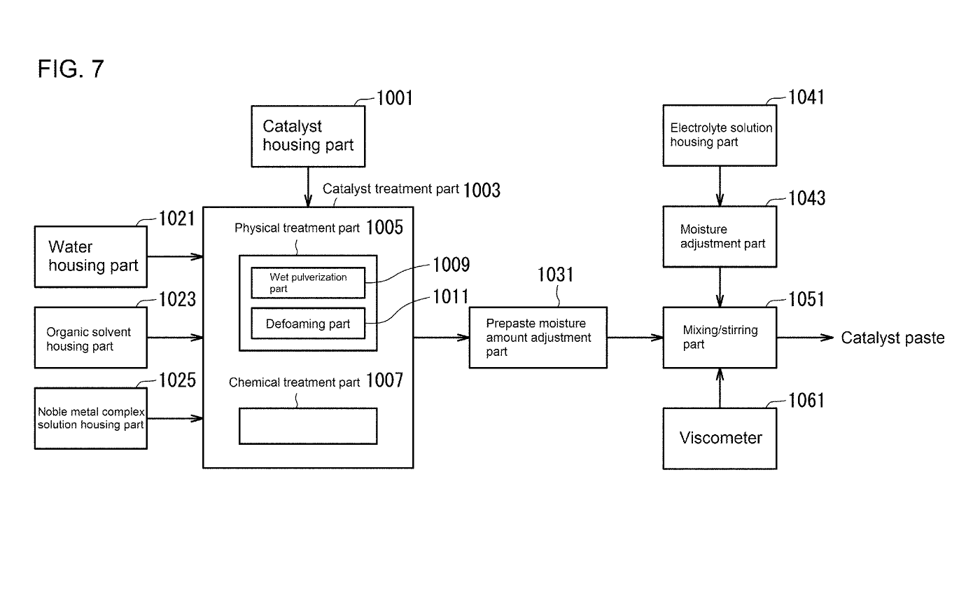

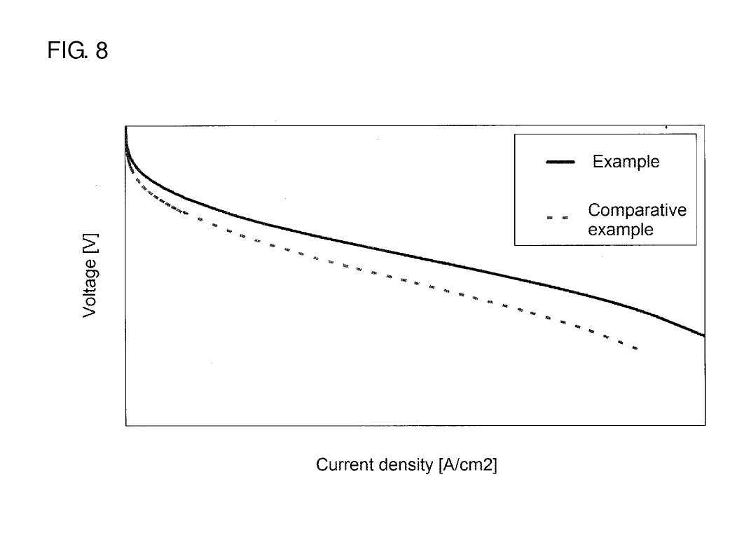

FIG. 7 is a block diagram showing an apparatus for producing a catalyst paste.

A catalyst, water, a noble metal complex, and an electrolyte which serve as starting materials for the catalyst paste are provided in a catalyst housing part 1001, a water housing part 1021, a noble metal complex solution housing part 1025, and an electrolyte solution housing part 1041, respectively. In the meantime, an organic solvent for washing off an organic matter from the catalyst is provided in an organic solvent housing part 1023. Tanks formed of materials and having a capacity according to the objects to be housed can be utilized as the respective housing parts.

A catalyst treatment part 1003 includes a physical treatment part 1005 and a chemical treatment part 1007. The physical treatment part 1005 includes a wet pulverization part 1009 and a defoaming part 1011. A homogenizer, a wet jet mill or the like can be used as the wet pulverization part 1009. A hybrid mixer or the like can be used as the defoaming part 1011. A generally-used stirring device including a stirring blade can be applied as the chemical treatment part 1007. When a noble metal complex having high reactivity to the metal catalyst particles is employed, the chemical reaction can also be completed by injecting the noble metal complex solution into a pipeline for distributing the catalyst slurry.

Since the catalyst is dispersed in a large amount of water to form a prepaste in a slurry form in the catalyst treatment part, the amount of moisture in the prepaste is adjusted in a moisture amount adjustment part 1031.

In this case, moisture would be removed from the slurry-like prepaste, and thus a well-known concentrating method (for example, a heating evaporation device, a filtering device, and a centrifugal separating device) or the like can be used. Further, since the moisture amount can be specified from the specific weight of the prepaste, the moisture amount adjustment part preferably includes a specific weight measuring device. Also, the part preferably includes a moisture supplementing device on the assumption of the case where the moisture amount of the prepaste becomes too small.

A moisture adjustment part 1043 for the electrolyte solution preferably includes a heat-evaporating device and a water supplementing device. Since the moisture amount can be specified from the specific weight of the prepaste, preferably, the moisture amount adjustment part further includes a specific weight measuring device.

A mixing/stirring part 1051 mixes/stirs the prepaste and electrolyte solution each adjusted in terms of moisture content, and, for example, a hybrid mixer can be used, but the mixing/stirring part is not limited to this. In the meantime, a viscometer 1061 is preferably provided in the mixing/stirring part 1051 in order to avoid excessive stirring.

In the present invention, the catalyst treatment, especially, chemical treatment is improved in the steps of producing the above-described PFF.

That is, the surface of the carrier of the catalyst is modified with an acidic functional group.

Here, one or two or more of a hydroxyl group, a carboxyl group, a carbonyl group, a sulfonic acid group, a nitro group, a nitric acid group, a nitrous acid group, and a phosphate group can be used as the acidic functional group.

These acidic functional groups modify the entire surface of the carrier of the catalyst. As a result, the peripheral surfaces of micropores therein would also be modified with acidic functional groups.

While the method for modifying the catalyst with the acidic functional group can be arbitrarily selected depending on the properties of the carrier and acidic functional group dissolved in a solvent, the modification is basically carried out by contacting them with each other. This modification causes covalent bonding of the acidic functional group with the carrier of the catalyst.

When modified with the acidic functional group, a carrier having no catalyst metal particle supported thereon is preferably employed, but, of course, the acidic functional group may be contacted with a carrier (i.e., catalyst) having catalyst metal particles supported thereon.

Since the inside of an electrolyte membrane which covers the catalyst is filled with the generated water in the PFF structure, the micropores in the carrier and the gaps among the catalyst particles are also filled with water. Thus, if the acidic functional group is present on the surface of the carrier of the catalyst which constitutes these features in the micropores and gaps among the catalyst particles, protons are supplied to water from this acidic functional group. Accordingly, even if the electrolyte cannot sufficiently get into the micropores or gaps among the catalyst particles, these protons can contribute to a fuel cell reaction on the catalyst metal particles.

This can improve the utilization efficiency of the catalyst metal particles made of an expensive noble metal such as platinum and thus can realize the improvement in efficiency of the fuel cell reaction.

The present invention is not limited by the modes for carrying out the invention and the explanation about Examples. The present invention also encompasses various variant embodiments within the scope which would be obvious to those skilled in the art without departing from the scope of claims.

Hereinafter, the following matter is disclosed.

(1) A method for producing a catalyst for a reaction layer of a fuel cell having a PFF structure, the method including an acidic functional group modifying step for modifying a carrier of a catalyst with an acidic functional group.

(2) The catalyst production method according to (1), wherein the acidic functional group modifying step includes a first imparting step for modifying the carrier with a weakly-acidic functional group and, subsequent to the first imparting step, a second imparting step for modifying the carrier with a strongly-acidic functional group.

(3) The catalyst production method according to (2), wherein

the first step is carried out by contacting the carrier with hydrogen peroxide water; and

the second step is carried out by contacting the carrier with an aqueous nitric acid solution, an aqueous sulfuric acid solution or an aqueous solution mixture thereof.

(4) A catalyst production method, including applying the acidic functional group modifying step as defined in any of (1) to (3) to a carrier having no catalyst metal particle supported thereon and then supporting catalyst metal particles on the carrier.

(4) A catalyst for a reaction layer of a fuel cell, including a porous carrier and catalyst metal particles supported on the carrier and having a PFF structure, wherein

the inner peripheral surfaces of pores formed in the carrier are modified with an acidic functional group.

### EXPLANATION OF REFERENCE NUMERALS

C: Catalyst
C1: Carrier
C2: Catalyst metal particles
E: Electrolyte layer
W: Hydrophilic region

1. A catalyst for a fuel cell comprising a conductive carrier on which catalyst metal particles are supported, wherein
the surface of the carrier is modified with an acidic functional group, and the acidic functional group is one or two or more of a hydroxyl group, a carboxyl group, a carbonyl group, a sulfonic acid group, a nitro group, a nitric acid group, a nitrous acid group, and a phosphate group.

2. The catalyst for a fuel cell according to claim 1, wherein the acidic functional group has a Hammett acidity function of −3 or less.

3. The catalyst for a fuel cell according to claim 2, wherein the acidic functional group is a sulfonic acid group.

4. A method for producing a catalyst for a fuel cell comprising conductive carrier on which catalyst metal particles are supported, the method comprising:
modifying the carrier with a sulfonic acid group so that the Hammett acidity function is −3 or less.

5. The method according to claim 4, wherein modification of the carrier with a weakly-acidic functional group is followed by substitution of the weakly-acidic functional group by the sulfonic acid group.
